(19) United States
(12) Patent Application Publication
(10) Pub. No.: US 2013/0168471 A1
(43) Pub. Date: Jul. 4, 2013

(54) GARDENING SPRAY GUN

(71) Applicant: Chin-Yuan Chen, Changhua (TW)

(72) Inventor: Chin-Yuan Chen, Changhua (TW)

(73) Assignee: SHIN TAI SPURT WATER OF THE GARDEN TOOLS CO., LTD., CHANGHUA (TW)

(21) Appl. No.: 13/342,105

(22) Filed: Jan. 1, 2012

(51) Int. Cl. B05B 9/01

(52) U.S. Cl. 239/526

(57) ABSTRACT

A gardening spray gun includes a gun body having a water channel and a receiving space, a measuring hole formed between the receiving space and the water channel; a rotating unit disposed in the receiving space and a connecting portion extending therefrom, and the rotating unit having a measuring opening corresponding to the measuring hole of the receiving space; a clamp having two resilient arms extending therefrom to clamp the connecting portion of the rotating unit; and an adjusting unit having a covering slot and a handle portion, wherein the covering slot is used to cover the clamp, and the handle portion is flat to provide a hand-held portion to rotate the adjusting unit. The adjusting unit are used to drive the clamp and the rotating unit to generate changes of the measuring hole and measuring opening to control an adjust water flow while water is dispensed.

### FIELD OF THE INVENTION

The present invention relates to a spray gun structure, and more particularly to a gardening spray gun structure that can simultaneously perform water spraying and flow adjustment.

### BACKGROUND OF THE INVENTION

Referring to FIG. 10 for a conventional water spray gun, the water spray gun (70) has a head (71), a handle (72) and a connecting section (73) used to connect in between. A water control rod (74) is disposed at the connecting section (73), and one end of the water control rod (74) extends to the head (71) to slidingly switch between water dispensing/blocking. An adjustable nut (75) is disposed with threads (741) at the connecting section (73) of the other end of the water control rod (74). A pressing handle (76) is formed at the handle (72), and one end of the pressing handle (76) is disposed between the connecting section (73) and the adjustable nut (75). When the pressing handle (76) is pressed, the pressing handle (76) drives the adjustable nut (75) of the water control rod (74) to pull out the water control rod (74) to dispense water. On the other hand, when the user wants to adjust water flow, he/she has to rotate the adjustable nut (75) directly to change the sliding distance of the pressing handle (76) driving the water control rod (74) to further change the water flow.

According to the structure of the conventional water spray gun, it is disadvantageous because (a) when water is dispensed, the pressing handle (76) presses the adjustable nut (75), so the user cannot adjust it and it is inconvenient for the user to adjust the nut while using the spray gun. In other words, the user cannot adjust the water flow using instinct and it would be inconvenient if he/she has to adjust the flow several times to obtain an appropriate water flow; (b) whenever the water is dispensed, the pressing handle (76) presses the adjustable nut (75) so as to damage the threads (741), and it may be difficult for the user to rotate the adjustable nut (75). Also, it is difficult for the user using bare hands to rotate the adjustable nut (75), and tools are usually necessary; and (c) the spray gun (70) does not provide any space for hanging, so when it has to be temporarily placed, it can only be placed on the ground or table. There is no hanging functionality of the conventional structure. Therefore, there remains a need for a new and improved spray gun structure to overcome abovementioned problems.

### SUMMARY OF THE INVENTION

The problem to be solved in the present invention is to provide a new and improved gardening water spray gun to overcome abovementioned problems.

A gardening spray gun includes a gun body, a water blocking rod, a rotating unit, a locking unit, a clamp and an adjusting unit. A water channel is formed inside the gun body for water dispensing, and a receiving space and a sliding channel are formed across and through the water channel. A water blocking hole and a measuring hole are formed between the receiving space and the water channel, and a pressing bar is connected to the sliding channel of the gun body. The water blocking rod has a sliding rod portion and a water blocking head, wherein the sliding rod portion is slidingly disposed in the sliding channel and against the pressing bar, and the water blocking head is disposed in the receiving space and against the water blocking hole. The water blocking head also has a resilient unit. One end of the rotating unit presses the resilient unit and is disposed in the receiving space to push the water blocking rod to the pressing bar. A connecting portion extends from the other end of the rotating unit to the gun body, and the rotating unit has a measuring opening corresponding to the measuring hole of the receiving space. The locking unit is locked in the receiving space to form a restriction position of the water blocking rod and the rotating unit, and the connecting portion of the rotating unit penetrates through the locking unit. The clamp has two resilient arms extending therefrom that clamp the connecting portion of the rotating unit. The adjusting unit has a covering slot and a handle portion, and the adjusting unit uses the covering slot to cover the clamp, so that the resilient arms cannot escape from the connecting portion. The handle portion is flat to provide a hand-held portion to rotate the adjusting unit.

The main objective of the present invention is that the water blocking rod slides at the sliding channel of the gun body to control the open/close status of the water blocking head and the water blocking hole to achieve the goal of water dispensing. Also, when the water goes out, the water blocking rod is the only component that is being used, and the rotating unit, clamp and the adjusting unit are merely used for controlling water flow, so water dispensing and flow controlling are two independent operations, which can achieve the goal of dispensing water while adjusting water flow. In other words, the user can use his/her instinct to adjust the water flow while using the spray gun to easily control the water flow.

Another objective of the present invention is that the water blocking rod, rotating unit, locking unit, clamp and adjusting unit are all disposed on the gun body through the receiving space, so the number of component is low and the installation process is simplified to effectively reduce the costs.

A further objective of the present invention is that the resilient arms of the clamp are used to clamp the connecting portion of the rotating unit, and the covering slot of the adjusting unit coves the clamp, so the resilient arms cannot escape from the connecting portion to further secure the clamp and the adjusting unit. Even though the user does not use any tools, he/she can quickly assemble/disassemble the clamp and the adjusting unit. Moreover, the handle portion has the opening that provides a hanging functionality for the gun body to increase the practicability.

### BRIEF DESCRIPTION OF THE DRAWINGS

FIG. 1 illustrates a three-dimensional view in the present invention.

FIG. 2 illustrates an exploded three-dimensional view in the present invention.

FIG. 3 illustrates a sectional view of the gun body in the present invention.

FIG. 4 illustrates a sectional view of the assembly process in the present invention.

FIG. 5 illustrates a schematic sectional view of water dispensing process in the present invention.

FIG. 6 illustrates a schematic view of water flow control in the present invention.

FIG. 7 illustrates a second schematic view of water flow control in the present invention.

FIG. 8 illustrates a third schematic view of water flow control in the present invention.

FIG. 9 illustrates a schematic view of hanging status in the present invention.

FIG. 10 illustrates a schematic view of conventional water spray gun.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

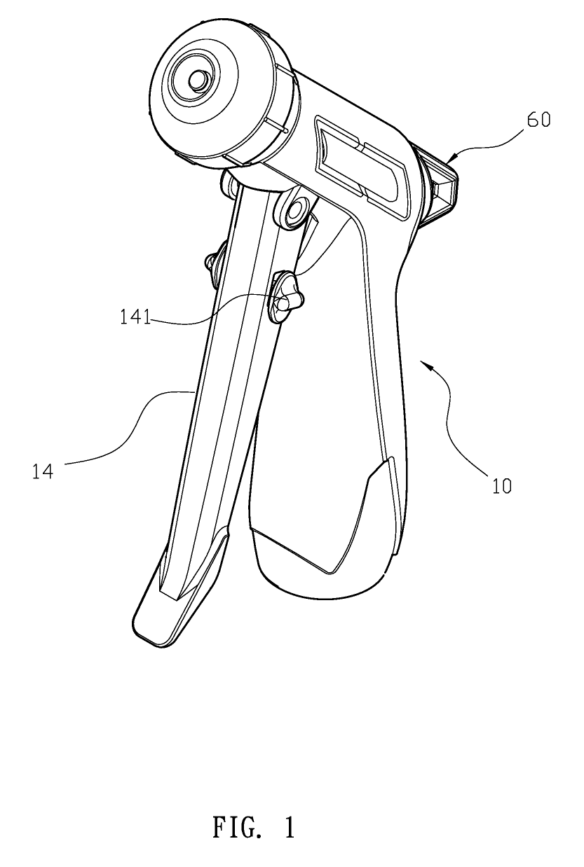

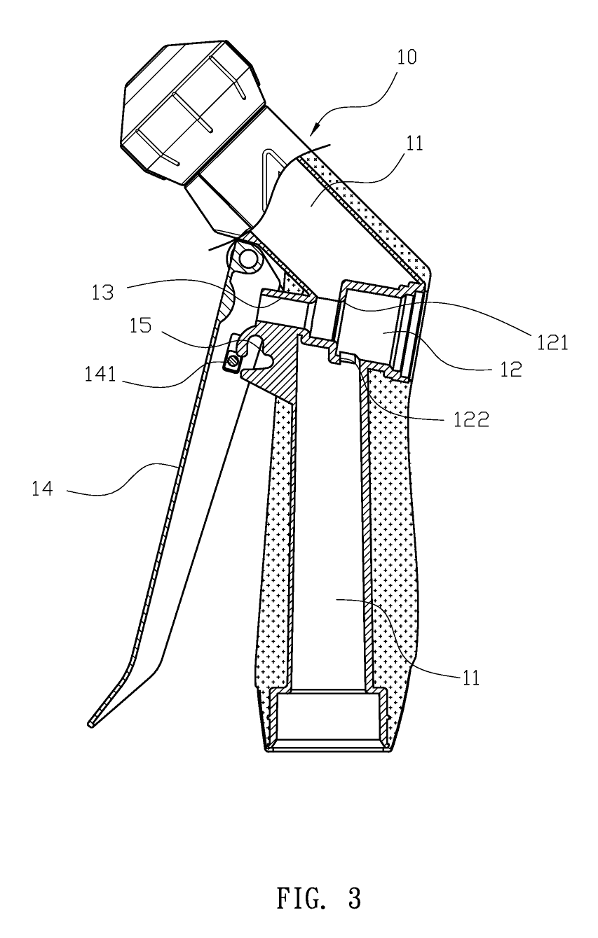

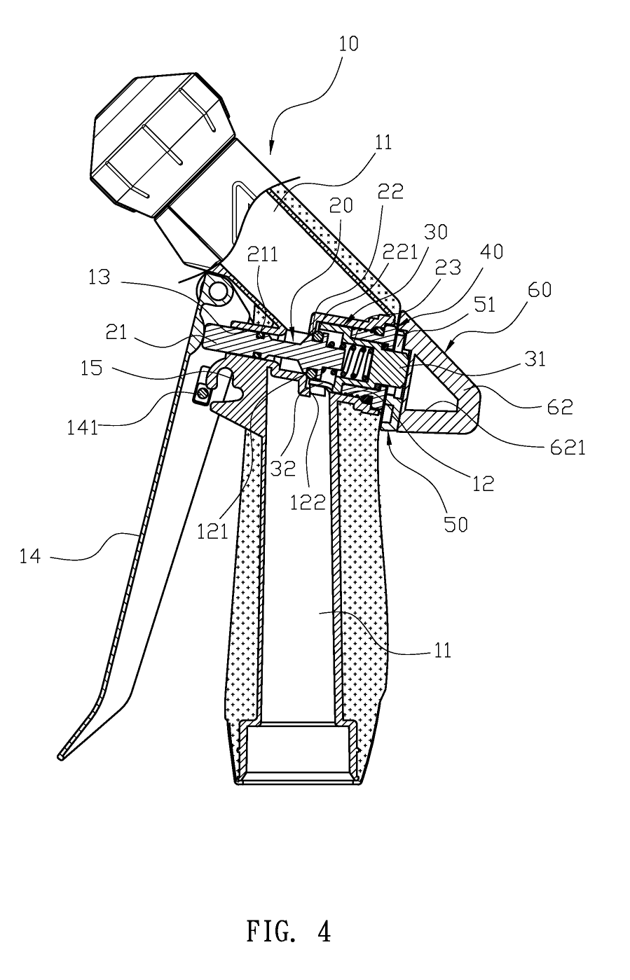

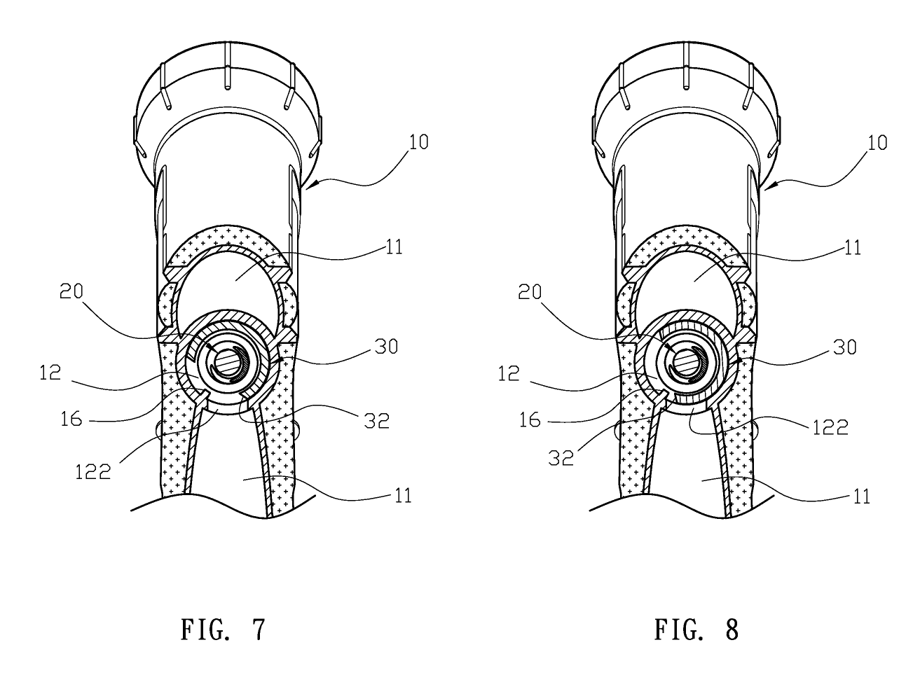

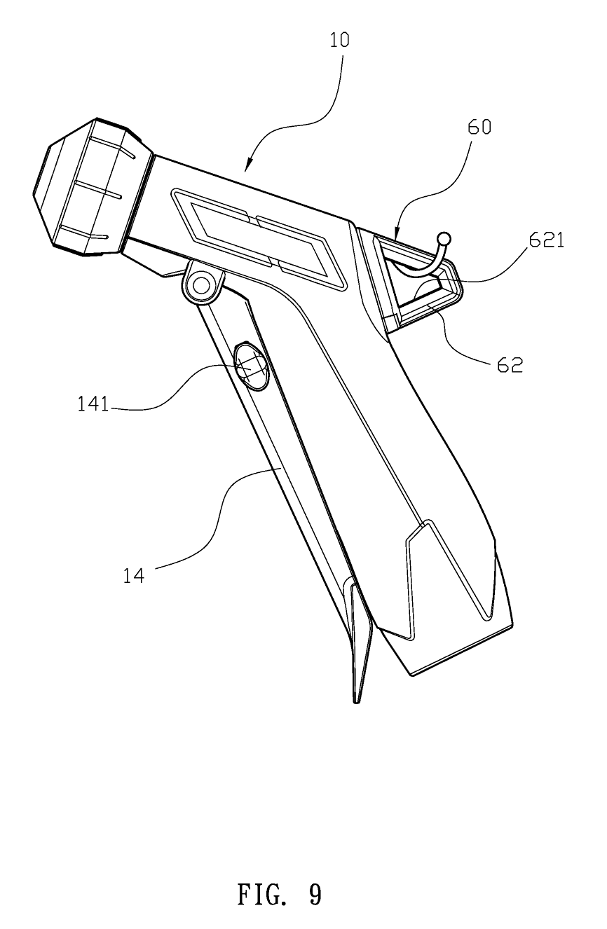

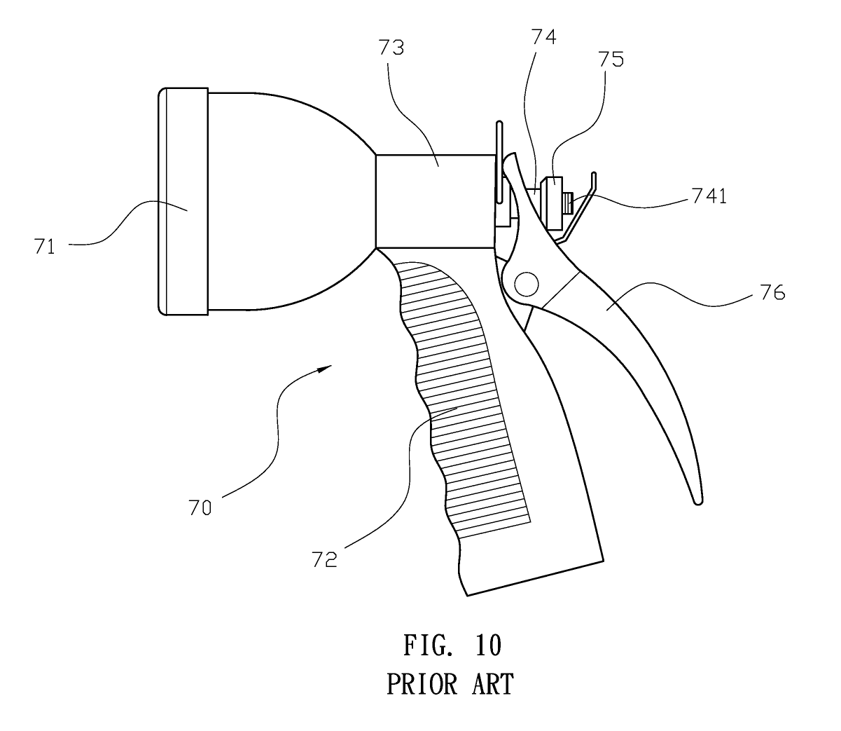

Referring to FIGS. 1 to 3, a gardening spray gun includes a gun body (10), a water blocking rod (20), a rotating unit (30), a locking unit (40), a clamp (50) and an adjusting unit (60). A water channel (11) is formed inside the gun body (10) for outgoing water, and a receiving space (12) and a sliding channel (13) are formed across and through the water channel (11). A water blocking hole (121) and a measuring hole (122) are formed between the receiving space (12) and the water channel (11). A pressing bar (14) is connected to the sliding channel (13) of the gun body (10), and the pressing bar (14) has a hooking unit (141) that is corresponding to a restricting slot (15) of the gun body (10). When the pressing bar (14) is rotated to be against the gun body (10) (see FIG. 9), the pressing bar (14)'s restricting effect can be achieved by inserting the hooking unit (141) into the restricting slot (15). The water blocking rod (20) has a sliding rod portion (21) and a water blocking head (22), wherein the sliding rod portion (21) is slidingly disposed in the sliding channel (13) and against the pressing bar (14), and the water blocking head (22) is disposed in the receiving space (12) and against the water blocking hole (121). The water blocking head (22) has a resilient unit (23), and when the pressing bar (14) pushes the water blocking rod (20) to separate the water blocking head (22) and the water blocking hole (121), the gun body (10) is in a water-spraying status. Gaskets (211) (221) are disposed at the sliding rod portion (21) and the water blocking head (22) of the water blocking rod (20) to achieve an anti-leaking effect of the sliding rod portion (21) and the water blocking head (22). A connecting portion (31) extends from one end of the rotating unit (30) to the gun body (10), and the rotating unit (30) has a measuring opening (32) corresponding to the measuring hole (122) of the receiving space (12). Referring to FIG. 7, a blocking unit (16) is protrudingly formed near the measuring hole (122) in the receiving space (12) of the bun body (10), and the blocking unit (16) is used to block the measuring opening (32) of the rotating unit (30) and further control the rotating angle of the rotating unit (30). The locking unit (40) is locked in the receiving space (12) to form a restriction position of the water blocking rod (20) and the rotating unit (30), and the connecting portion (31) of the rotating unit (30) penetrates through the locking unit (40). The clamp (50) has two resilient arms (51) extending therefrom, and the resilient arms (51) clamp the connecting portion (31) of the rotating unit (30). The rear end of the resilient arm (51) has a hook portion (511), wherein a non-circular recessed slot (311) is formed at the neck portion of the connecting portion (31) of the rotating unit (30), and a non-circular evasive opening (512) is formed between two resilient arms (51) of the clamp (50). The evasive opening (512) of the clamp (50) is used to tightly clamp the recessed slot (311) of the connecting portion (31), so that the clamp (50) can drive the rotating unit (30) to rotate. The adjusting unit (60) has a covering slot (61) and a handle portion (62), and the adjusting unit (60) uses the covering slot (61) to cover the clamp (50), so that the resilient arms (51) cannot escape from the connecting portion (31). The covering slot (61) has two protruding portion (611) facing each other, and two protruding portions (611) engage the hook portions (511) of the resilient arms (51) to secure of the clamp (50) and adjusting unit (60). The handle portion (62) is flat to provide a hand-held portion to rotate the adjusting unit (60), and the handle portion (62) has an opening (621) to provide a hanging functionality (see FIG. 9). The adjusting unit (60) is used to drive the clamp (50) and the rotating unit (30) to generate changes of the measuring hole (122) and measuring opening (32) to achieve the results of adjusting water flow using a simple structure, as well as simultaneously adjusting water flow when water goes out.

Referring to FIGS. 1 to 3 for the structure of the present invention, the sliding rod portion (21) of the water blocking rod (20) inserts into the receiving space (12) of the gun body (10), so that the sliding rod portion (21) is disposed at the sliding channel (13), and the rear end of the sliding rod portion (21) is against the pressing bar (14). Also, the water blocking head (22) of the water blocking rod (20) is disposed at the receiving space (12), and forms a sealing effect of the water channel (11) and receiving space (12) when disposed closely to the water blocking hole (121). The resilient unit (23) is disposed in the receiving space (12), one end of which is pressed at the water blocking head (22). Furthermore, the rotating unit (30) is disposed in the receiving space (12) of the gun body (10), so that the rotating unit (30) can compress the other end of the resilient unit (23). The measuring opening (32) of the rotating unit (30) is aligned with the measuring hole (122) of the receiving space (12), and the connecting portion (31) protrudingly extends to the outer portion of the gun body (10). The locking unit (40) is located in the receiving space (12) to form the restricting effect of the water blocking rod (20) and the rotating unit (30). Also, the connecting portion (31) of the rotating unit (30) penetrates through the locking unit (40), and the clamp (50) clamps the recessed slot (311) of the connecting portion (31) via the evasive opening (512) of the resilient arms (51), so that the clamp (50) is disposed at the connecting portion (31) of the gun body (10). Finally, the covering slot (61) of the adjusting unit (60) slidingly covers the clamp (50) using the hook portion (511) of the clamp (50), and the hook portion (511) engage the protruding portion (611) of the covering slot (61) to quickly secure the clamp (50) and the adjusting unit (60) on the rotating unit (30) to complete the assembly process.

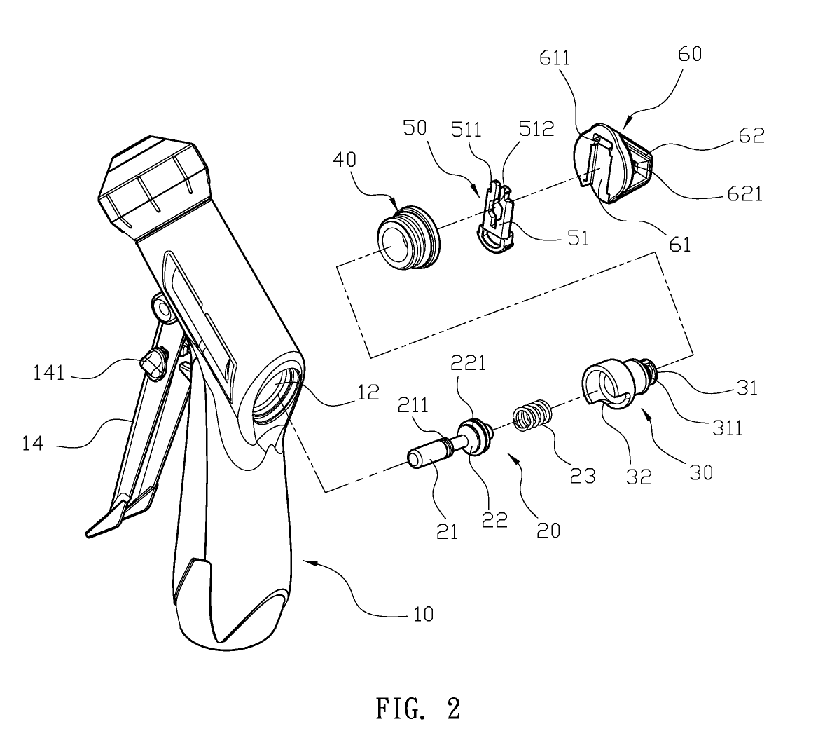

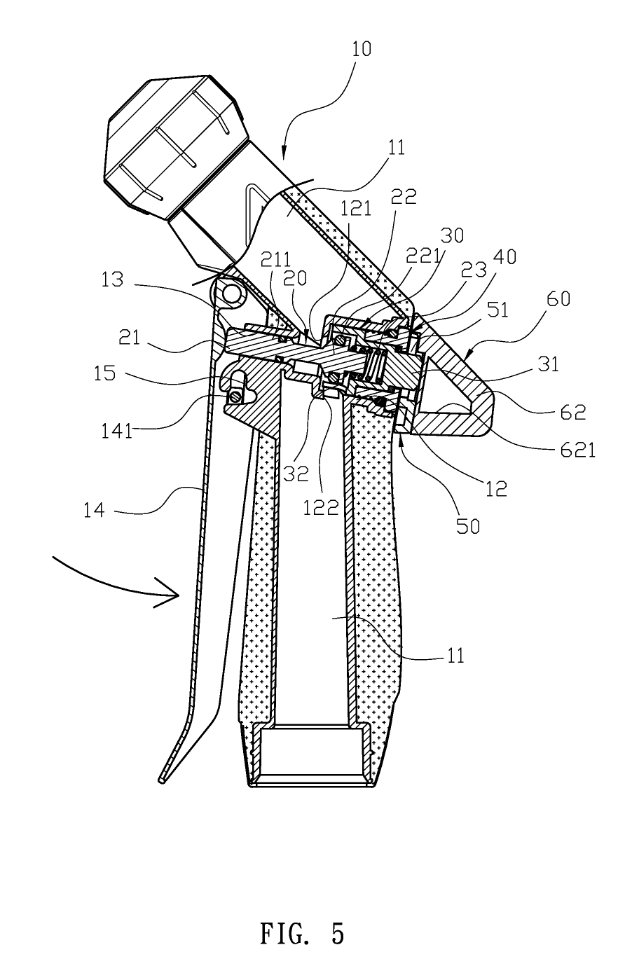

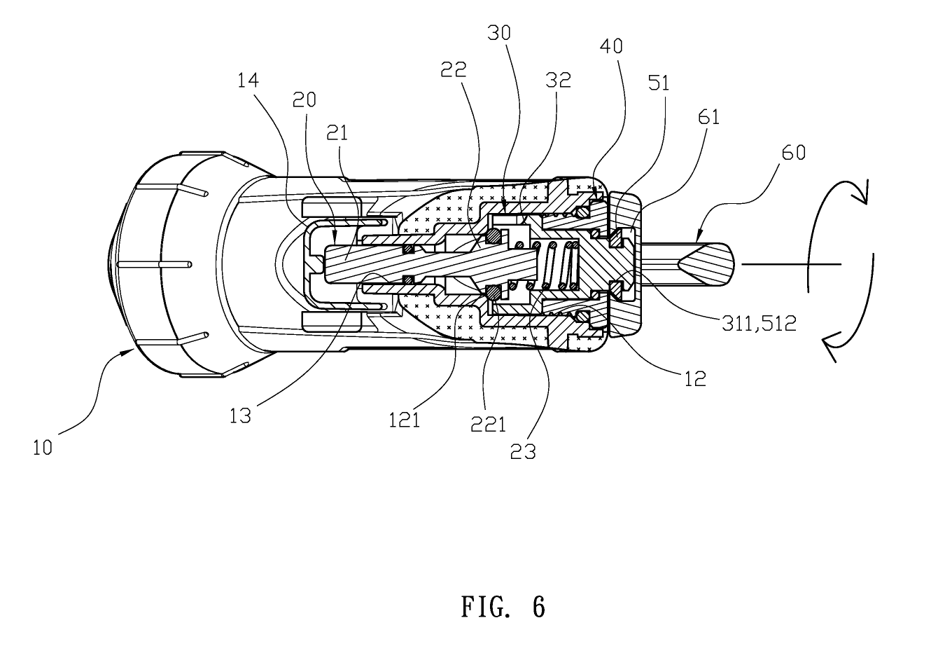

Referring to FIGS. 2 and 5 as to the usage of the present invention, when water goes out from the gun body (10), the pressing bar (14) is pressed to simultaneously push the water blocking rod (20) at the sliding channel (13) to drive the water blocking rod (20) toward the direction of the receiving space (12). The water blocking head (22) and the water blocking hole (121) then separates to generate a water dispensing effect when the water flows from the measuring hole (122) to the receiving space (12) and the water blocking hole (121). When the pressing bar (14) is released, the water blocking rod (20) is pushed to restore by the resilient unit (23) to seal the water blocking head (22) and the water blocking hole (121) and to achieve the result of water flow control. Referring to FIGS. 6 to 8, when a user wants to control the water flow, the user can simply rotate the handle portion (62) of the adjusting unit (60), and the covering slot (61) of the adjusting unit (60) can drive the clamp (50) to rotate at the same time. The non-circular evasive opening (512) of the clamp (50) clamps the recessed slot (311) of the rotating unit (30), so that the clamp (50) can drive the rotating unit (30) to rotate, and adjust a overlapping space between the measuring opening (32) of the rotating unit (30) and the measuring hole (122) of the gun body (10), and further control flow of the water flowing through the water blocking hole (121) to achieve the goal of easy handling. Moreover, the water blocking rod (20), rotating unit (30), locking unit (40), clamp (50) and adjusting unit (60) are all disposed on the gun body (10) through the receiving space (12), so it is advantageous that the number of component is low and the installation process is simplified. Also, when the water goes out, the water blocking rod (20) is the only component that is being used, and the rotating unit (30), clamp (50) and the adjusting unit (60) are merely used for controlling water flow, so water dispensing and flow controlling are two independent operations, which can achieve the goal of dispensing water while adjusting water flow. In other words, the user can use his/her instinct to adjust the water flow while using the spray gun to increase its practicability.

According to the embodiment stated above, the present invention is advantageous because (a) the water blocking rod (20) slides at the sliding channel (13) of the gun body (10) to control the open/close status of the water blocking head (22) and the water blocking hole (121) to achieve the goal of water dispensing. Also, when the water goes out, the water blocking rod (20) is the only component that is being used, and the rotating unit (30), clamp (50) and the adjusting unit (60) are merely used for controlling water flow, so water dispensing and flow controlling are two independent operations, which can achieve the goal of dispensing water while adjusting water flow. In other words, the user can use his/her instinct to adjust the water flow while using the spray gun to easily control the water flow; (b) the water blocking rod (20), rotating unit (30), locking unit (40), clamp (50) and adjusting unit (60) are all disposed on the gun body (10) through the receiving space (12), so the number of component is low and the installation process is simplified to effectively reduce the costs; and (c) the resilient arms (51) of the clamp (50) are used to clamp the connecting portion (31) of the rotating unit (30), and the covering slot (61) of the adjusting unit (60) coves the clamp (50), so the resilient arms (51) cannot escape from the connecting portion to further secure the clamp (50) and the adjusting unit (60). Even though the user does not use any tools, he/she can quickly assemble/disassemble the clamp (50) and the adjusting unit (60). Moreover, the handle portion (62) has the opening (621) that provides a hanging functionality for the gun body to increase the practicability.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A gardening spray gun comprising:
a gun body, wherein a water channel is formed inside the gun body for water dispensing, and a receiving space and a sliding channel are formed across and through the water channel, and a measuring hole is formed between the receiving space and the water channel;
a rotating unit disposed in the receiving space, wherein a connecting portion extends from one end of the rotating unit to the gun body, and the rotating unit has a measuring opening corresponding to the measuring hole of the receiving space;
a clamp having two resilient arms extending therefrom to clamp the connecting portion of the rotating unit; and
an adjusting unit having a covering slot and a handle portion, wherein the covering slot is used to cover the clamp, so that the resilient arms are not able to escape from the connecting portion, and the handle portion is flat to provide a hand-held portion to rotate the adjusting unit, and the handle portion has an opening that providing hanging functionality, wherein the adjusting unit drives the clamp and the rotating unit to generate changes of the measuring hole and measuring opening to control an adjust water flow while water is dispensed.

2. The gardening spray gun of claim 1, wherein a sliding channel is formed across and through the water channel, and a water blocking hole is formed between the receiving space and the water channel, and a pressing bar is connected to the sliding channel of the gun body, wherein the gun body has a water blocking rod having a sliding rod portion and a water blocking head, and the sliding rod portion is slidingly disposed in the sliding channel and against the pressing bar, and the water blocking head is disposed in the receiving space and against the water blocking hole, wherein the pressing bar pushes the water blocking rod to separate the water blocking head and the water blocking hole to facilitate water dispensing.

3. The gardening spray gun of claim 2, wherein the pressing bar has a hooking unit corresponding to a restricting slot of the gun body, and when the pressing bar is rotated to be against the gun body, the pressing bar's restricting effect is achieved by inserting the hooking unit into the restricting slot.

4. The gardening spray gun of claim 2, wherein a resilient unit is disposed at the water blocking head of the water blocking rod, and the rotating unit is disposed into the receiving space to press the resilient unit to provide resilience for the water blocking rod to push the pressing bar.

5. The gardening spray gun of claim 4, further comprising a locking unit that is locked in the receiving space to form a restriction position of the water blocking rod and the rotating unit, and connecting portion of the rotating unit penetrates through the locking unit.

6. The gardening spray gun of claim 4, wherein the water blocking rod has a gasket each disposed at the sliding rod portion and water blocking head to generate an anti-leaking effect for the sliding rod portion and water blocking.

7. The gardening spray gun of claim 1, wherein a hook portion is formed at each rear end of the resilient arm, and two corresponding protruding portions are formed at the covering slot of the adjusting unit to engage the hook portions to form secure the clamp and adjusting unit.

8. The gardening spray gun of claim 1, wherein a non-circular recessed slot is formed at a neck portion of the connecting portion of the rotating unit, and a non-circular evasive opening is formed between two resilient arms of the clamp to clamp the recessed slot of the connecting portion, so that the clamp is allowed to drive the rotating unit to rotate.

9. The gardening spray gun of claim 1, wherein a blocking unit is disposed in the receiving space near the measuring hole blocking unit to block the measuring opening of the rotating unit and further control rotating angle of the rotating unit.
